(19) United States
(12) Patent Application Publication
(10) Pub. No.: US 2006/0219270 A1
(43) Pub. Date: Oct. 5, 2006

(54) Method for cleaning and transporting rubber stoppers and apparatus for cleaning and transporting rubber stoppers

(76) Inventors: Katsuhiro Ando, Osaka (JP); Kyoichi Saeki, Osaka (JP); Takuo Mochizuki, Niigata (JP); Masami Tanaka, Niigata (JP)

Correspondence Address: WENDEROTH, LIND & PONACK, L.L.P., 2033 K STREET N. W., SUITE 800, WASHINGTON, DC, 20006-1021, US

(21) Appl. No.: 11/261,674

(22) Filed: Oct. 31, 2005

(30) Foreign Application Priority Data
Mar. 31, 2005 (JP) 2005-102848

(51) Int. Cl. B08B 5/04; B08B 7/00; B08B 3/00

(52) U.S. Cl. 134/34; 134/33; 134/21; 134/198; 134/137

(57) ABSTRACT

A method for cleaning and transporting rubber stoppers includes the steps of ejecting pressurized water, fed from a water storage division, from a jet nozzle to form a jet stream flowing into a negative pressure-creating pipe for suction to create a negative pressure inside the negative pressure-creating pipe; transporting rubber stoppers placed in a storage section to the negative pressure-creating pipe through a cleaning inlet port placed under the storage section using the negative pressure; cleaning the rubber stoppers with the jet stream while the rubber stoppers are being transported through the negative pressure-creating pipe and then a transportation pipe directly connected to the negative pressure-creating pipe; transporting the rubber stoppers to a water separation section to remove water from the rubber stoppers; and transporting the rubber stoppers to a stocker for storing the cleaned rubber stopper.

### BACKGROUND OF THE INVENTION

1. Field of the Invention

The present invention relates to a method for cleaning and transporting rubber stoppers for drug or medical use and an apparatus for cleaning and transporting such rubber stoppers.

2. Description of the Related Art

Japanese Unexamined Patent Application Publication No. 2003-62037 (hereinafter referred to as Patent Document 1) discloses a technique for manufacturing a rubber stopper for sealed containers such as vials, syringes, bags, and plastic bottles. This rubber stopper is prepared by subjecting an elastic material such as chlorinated butyl rubber to injection molding. The obtained rubber stopper is then subjected to a cleaning step, whereby the following contaminants attached to the rubber stopper are removed: molding scrap, paper chips, operator's hairs, fine particles with a size of 100 to 500 μm.

Japanese Unexamined Patent Application Publication No. 2001-87351 (hereinafter referred to as Patent Document 2) discloses a technique for cleaning rubber stoppers. In this technique, a predetermined number of the rubber stoppers are placed in a processing vessel such as an autoclave and then cleaned with a cleaning solution.

In the technique disclosed in Patent Document 1, the rubber stopper is cleaned with an alkaline aqueous solution such as an aqueous sodium hydroxide solution or another solution and the used solution is neutralized with an acidic aqueous solution such as an aqueous hydrochloric acid solution or another solution. Therefore, this technique is problematic in that the cost for cleaning the rubber stopper is high because it takes much time and manpower to clean the rubber stopper, the alkaline and acidic aqueous solutions are consumed, and it costs to dispose of the used solutions.

The technique disclosed in Patent Document 2 is problematic in that the rubber stoppers are cleaned in a batch mode; hence, the use of this technique leads to a reduction in productivity.

### SUMMARY OF THE INVENTION

The present invention has been made to solve the above problems. It is an object of the present invention to provide a method and apparatus for continuously cleaning rubber stoppers without using any chemicals.

A method for cleaning and transporting rubber stoppers according to the present invention includes the steps of ejecting pressurized water, fed from a water storage division, from a jet nozzle to form a jet stream flowing into a negative pressure-creating pipe for suction to create a negative pressure inside the negative pressure-creating pipe; transporting rubber stoppers placed in a storage section to the negative pressure-creating pipe through a cleaning inlet port placed under the storage section using the negative pressure; cleaning the rubber stoppers with the jet stream while the rubber stoppers are being transported through the negative pressure-creating pipe and then a transportation pipe directly connected to the negative pressure-creating pipe; transporting the rubber stoppers to a water separation section to remove water from the rubber stoppers; and transporting the rubber stoppers to a stocker for storing the cleaned rubber stopper.

An apparatus for cleaning and transporting rubber stoppers according to the present invention includes a storage section, having a cleaning inlet port placed under the storage section, for storing rubber stoppers; a cleaning/transporting unit connected to the cleaning inlet port; and a water separation section for removing water from the rubber stoppers cleaned with the cleaning/transporting unit. The cleaning/transporting unit includes a negative pressure-creating pipe for suction and a jet nozzle for ejecting pressurized water fed from a water storage division to form a jet stream flowing into the negative pressure-creating pipe to create a negative pressure inside the negative pressure-creating pipe. The rubber stoppers placed in the storage section are discharged through the cleaning inlet port using the negative pressure and then cleaned during the transportation thereof.

According to the method or apparatus of present invention, the rubber stoppers are transported with the jet stream formed by ejecting the water fed from the water separation section from the jet nozzle and the following contaminants attached to the rubber stoppers are removed therefrom by the strong force of the jet stream during the transportation of the rubber stoppers: molding scrap, paper chips, operator's hairs, fine particles with a size of 100 to 500 μm. Hence, the rubber stoppers can be successfully cleaned.

Therefore, in the method or apparatus of the present invention, it is not necessary that an alkaline aqueous solution used to clean the rubber stoppers is neutralized with an acidic aqueous solution, unlike known methods or apparatuses. For example, the manpower needed to prepare the solutions and the manpower needed to treat the used solutions are not necessary. Hence, the method and apparatus of the present invention are advantageous in enhancing operation efficiency.

Furthermore, since the rubber stoppers are cleaned with the water stored in the water storage division without using such alkaline and acidic solutions, the method and apparatus of the present invention are advantageous in reducing running cost.

Since the rubber stoppers are cleaned while the rubber stoppers are being transported, the rubber stoppers can be continuously treatment.

As described above, the rubber stoppers can be continuously cleaned unlike known methods using a batch-type apparatus such as an autoclave. Accordingly, the method and apparatus of the present invention are advantageous in enhancing productivity.

### BRIEF DESCRIPTION OF THE DRAWINGS

FIG. 1 is a perspective view showing a rubber stopper;

FIG. 2 is a front elevational view in partial cross section showing an apparatus for cleaning and transporting rubber stoppers according to the present invention;

FIG. 3 is a plan view showing the apparatus;

FIG. 4 is a side view showing the apparatus; and

FIG. 5 is a vertical sectional side view showing a jet nozzle included in the apparatus.

### DESCRIPTION OF THE PREFERRED EMBODIMENTS

Preferred embodiments of the present invention will now be described with reference to the accompanying drawings.

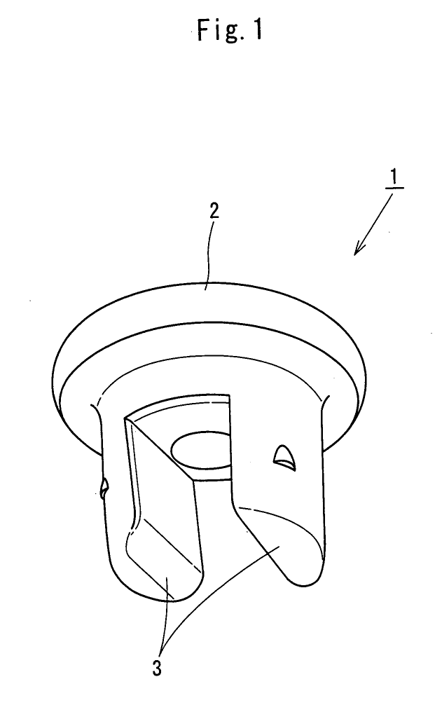

FIG. 1 is a perspective view showing one of rubber stoppers 1 cleaned and transported with an apparatus according to the present invention by a method according to the present invention.

The rubber stoppers 1 are suitable for sealed containers such as vials, syringes, bags, and plastic bottles and can be prepared by subjecting a resin material such as chlorinated butyl rubber to injection molding. The rubber stoppers 1 each include a disc-shaped head 2 and a tow-part leg section 3 extending from the center area of the lower face of the disc-shaped head 2.

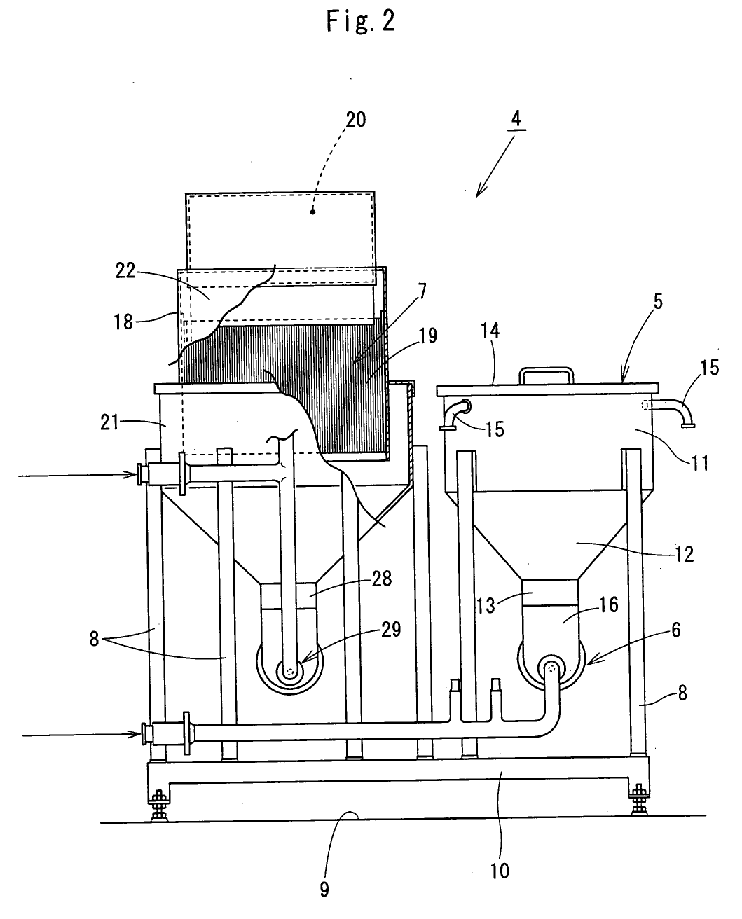

The following contaminants adhere to the rubber stoppers 1 during the preparation thereof: molding scrap, paper chips, operator's hairs, fine particles with a size of 100 to 500 μm. The contaminants are removed by cleaning the rubber stoppers 1 with a cleaning/transporting apparatus 4, as shown in FIGS. 2 to 4, according to an embodiment of the present invention.

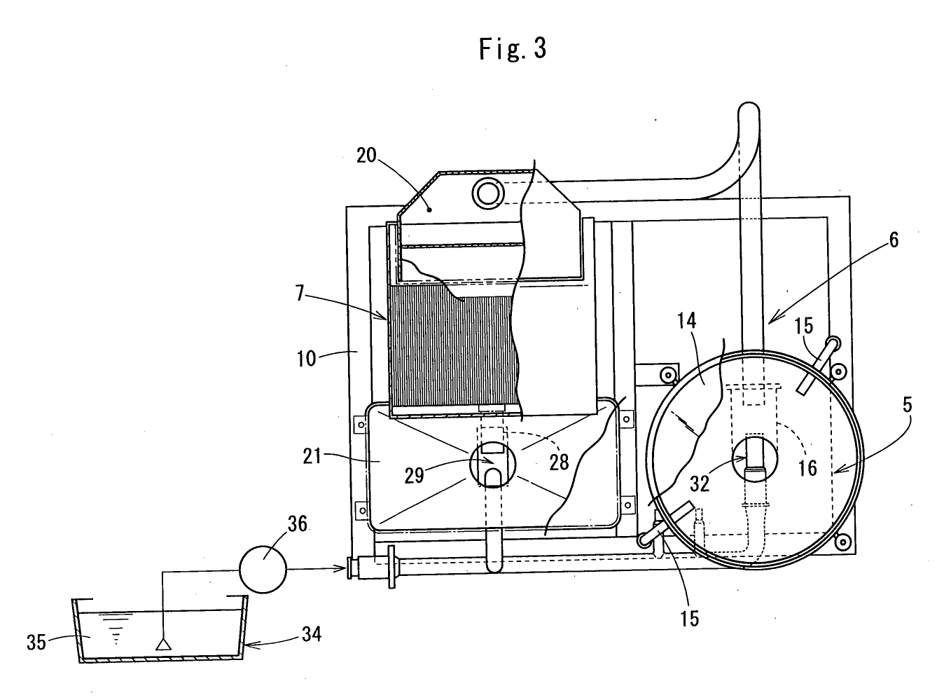

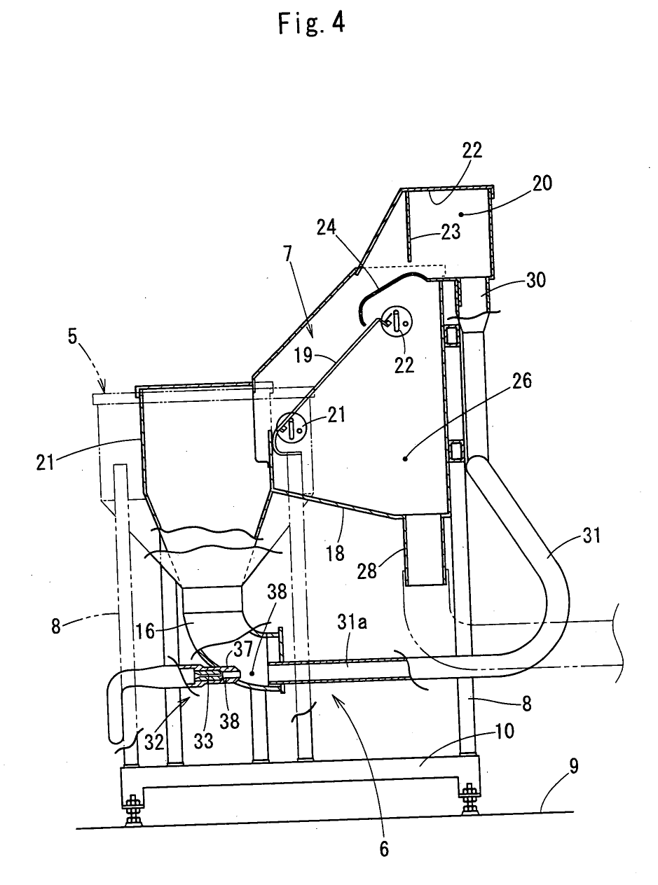

FIG. 2 is a front elevational view in partial cross section showing the cleaning/transporting apparatus 4. FIG. 3 is a plan view showing the cleaning/transporting apparatus 4. FIG. 4 is a side view showing the cleaning/transporting apparatus 4. The cleaning/transporting apparatus 4 includes a rubber stopper storage section 5 for storing the rubber stoppers 1, a cleaning/transporting unit 6, a water separation section 7 connected to the rubber stopper storage section 5 with the cleaning/transporting unit 6 placed therebetween, support legs 8 for supporting the rubber stopper storage section 5 and the water separation section 7, and a base 10 on or above which those components are arranged. The cleaning/transporting apparatus 4 is placed on a floor 9.

The rubber stopper storage section 5 includes a cylindrical wall 11; a tapered bottom portion 12, placed under the wall 11, having a funnel shape; an outlet port 13 placed under the center area of the lower end of the bottom portion 12; a detachable lid 14 placed on the wall 11; and two water supply pipes 15 connected to upper portions of the wall 11.

The outlet port 13 is connected to a cleaning inlet member (cleaning inlet port) 16 bent at about 90 degrees. With reference to FIG. 4, the cleaning inlet member 16 is directly connected to a jet nozzle included in a cleaning/transporting unit 17 described below.

The water separation section 7 includes a casing 18; a water-permeable draining board 19 placed in the casing 18 in a slanted manner; a storage portion 20, placed above the draining board 19, for storing the rubber stoppers 1 transported from the cleaning/transporting unit 6; and a stocker 21, placed below the draining board 19, for storing the cleaned rubber stoppers 1.

The draining board 19 has a plurality of slits and is supported with a supporter mounted on a side face of the casing 18. The upper end and lower end of the draining board 19 are detachably fixed to the supporter. The draining board 19 may be replaced with another type of draining board and the position and slant angle of the draining board 19 can be varied depending on the type of the rubber stoppers 1, particularly the size thereof.

The storage portion 20 includes a top plate 22, a transfer plate 24 extending from the storage portion 20 to draining board 19, and a regulating plate 23 extending from the top plate 22 close to the transfer plate 24. The gap between the lower end of the regulating plate 23 and the transfer plate 24 is small such that the aggregated rubber stoppers 1 are prevented from passing through the gap therebetween.

In particular, the gap therebetween is preferably equal to about 1.5 times the height or diameter of the rubber stoppers 1.

The casing 18 includes a drain section 26 having a drain port 25.

The stocker 21 has substantially a rectangular shape when viewed from above and has an upper opening covered with a lid 27. The lower end of the draining board 19 is placed in a side area of the stocker 21.

The stocker 21, as well as the rubber stopper storage section 5, has a tapered lower portion having a funnel shape. An outlet pipe 28, bent at about 90 degrees, for recovering the cleaned rubber stoppers 1 is connected to the center area of the lower end of the tapered lower portion. The outlet pipe 28 has a curved portion connected to a jet pump system 29 for recovering or transporting the rubber stoppers 1.

The cleaning/transporting unit 6, which connects the rubber stopper storage section 5 to the water separation section 7, includes a flume pipe 31 for connecting the outlet port 13 to an inlet portion 30 placed at the bottom of the storage portion 20. The flume pipe 31 includes a straight pipe portion 31a (a negative pressure-creating pipe for suction) located to close to the rubber stopper storage section 5. The straight pipe portion 31a faces the cleaning inlet member 16, which is directly connected to a jet nozzle 33 included in a cleaning jet pump system 32.

The cleaning jet pump system 32 includes a multiphase jet pump.

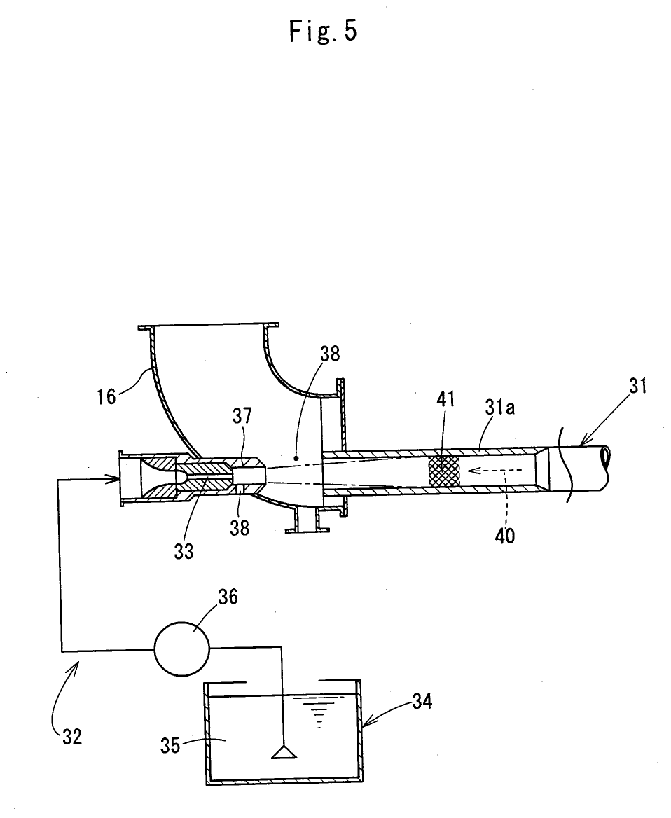

With reference to FIGS. 4 and 5, the cleaning jet pump system 32 includes a water storage division 34; a pressure pump 36 for pumping water 35 stored in the water storage division 34; the jet nozzle 33 for ejecting the water 35 pressurized with the pressure pump 36; and an air layer-forming tube 37, placed downstream of the jet nozzle 33, extending in the direction the water 35 is ejected. The air layer-forming tube 37 has an air intake port 38 placed in a lower portion thereof. A suction space 38 is present between the air layer-forming tube 37 and the straight pipe portion 31a, the suction space 38 being located downstream of the air layer-forming tube 37.

The jet pump system 29 has substantially the same configuration as that of the cleaning jet pump system 32.

A cleaning/transporting method according to an embodiment of the present invention will now be described with reference to the cleaning/transporting apparatus 4 having the above configuration.

The rubber stoppers 1 prepared by injection molding are dirty with a releasing agent or dust. The rubber stoppers 1 are fed into the rubber stopper storage section 5. The pressure pump 36 is then turned on.

As shown in FIG. 4, high-pressure water pressurized with the pressure pump 36 is ejected from the jet nozzle 33 into the air layer-forming tube 37. Since a jet stream (a pressurized fluid) flows in the air layer-forming tube 37 at high speed, the inside of the air layer-forming tube 37 is depressurized according to the Bernoulli theorem.

Outside air is introduced into the air layer-forming tube 37 through the air intake port 38 because the inside of the air layer-forming tube 37 is maintained at a negative pressure.

The air introduced into the air layer-forming tube 37 is captured by the jet stream flowing in the air layer-forming tube 37. The resulting jet stream is surrounded by an air layer and thereby converted into a multiphase jet stream, which flows into the straight pipe portion 31a.

Since the multiphase jet stream flowing in the straight pipe portion 31a is surrounded by the air layer, the friction between the inner face of the straight pipe portion 31a and the multiphase jet stream is low; hence, the speed of the multiphase jet stream is prevented from being reduced.

Since the multiphase jet stream flows in the straight pipe portion 31a against the drag indicated by Arrow 40, the thickness of the surrounding air layer is reduced. The suction pressure, that is, the back pressure, applied to the multiphase jet stream is increased due to the water head between the straight pipe portion 31a and the storage portion 20, the resistance (air resistance, frictional resistance, or the like) in the straight pipe portion 31a, and/or the plugging of the outlet port 13. Therefore, the multiphase jet stream is expanded in the straight portion 31a. This leads to the formation of an imaginary piston 41 indicated by the reticulated section shown in FIG. 5. The imaginary piston 41 acts as a turbulent flow and continuously moves in the right direction of FIG. 5.

Once the imaginary piston 41 is formed, a negative pressure is created in the inside of the straight pipe portion 31a, the inner portion being located upstream of the imaginary piston 41; hence, the rubber stoppers 1 placed in the rubber stopper storage section 5 are pulled into the straight pipe portion 31a.

The rubber stoppers 1 pulled into the straight pipe portion 31a are transported toward the storage portion 20 through the flume pipe 31 in such a manner that the rubber stoppers 1 are buffeted about by the multiphase jet stream with a strong force.

While the rubber stoppers 1 are being transported toward the storage portion 20, the rubber stoppers 1 are cleaned with the multiphase jet stream and caused to collide with each other, whereby the following contaminants attached to the rubber stopper are removed: molding scrap, paper chips, operator's hairs, fine particles with a size of 100 to 500 μm.

The rubber stoppers 1 transported with the multiphase jet stream arrive at the storage portion 20 and then pass through the gap between the lower end of the regulating plate 23 and the transfer plate 24. The rubber stoppers 1 passing through the gap are regulated by the regulating plate 23 such that the rubber stoppers 1 are prevented from being aggregated. The resulting rubber stoppers 1 are transported to the draining board 19 through the transfer plate 24.

Water is removed from the rubber stoppers 1 while the rubber stoppers 1 are sliding down on draining board 19. The resulting rubber stoppers 1 are transported to the stocker 21. A showering unit may be placed above the draining board 19 such that the rubber stoppers 1 are cleaned with fresh water discharged from the showering unit.

The rubber stoppers 1 transported to the stocker 21 are directly recovered through the outlet pipe 28 placed under the stocker 21 or further transported to another section with the jet pump system 29 connected to the outlet pipe 28.

In the method or apparatus described above, the multiphase jet stream is used and any jet stream may be used within the scope of the present invention. For example, high-pressure water may be directly ejected from the jet nozzle 33 into the straight pipe portion 31a.

The jet nozzle 33 is directly connected to the cleaning inlet member 16 placed under the outlet port 13 as shown in FIG. 4; however, the apparatus of the present invention is not limited such a configuration. The jet nozzle 33 may be directly connected to the outlet port 13.

This can be applied to a jet nozzle of the jet pump system 29 connected to the outlet pipe 28.

Although the fresh rubber stoppers 1 prepared by injection molding are cleaned such that the contaminants attached to the rubber stoppers 1 are removed, the method and apparatus of the present invention may be used to clean the rubber stoppers 1. In this case, the jet nozzle 33 and/or the showering unit preferably discharges a sanitizer solution instead of the high-pressure water or the fresh water, respectively.

Furthermore, the rubber stoppers 1 placed in the rubber stopper storage section 5 are transported to stocker 21 and then recovered from the stocker 21 in one shot. However, the rubber stoppers 1 placed in the stocker 21 may be fed back to the rubber stopper storage section 5 and then cleaned with the cleaning/transporting unit 6. This operation may be repeated a plurality of times.

1. A method for cleaning and transporting rubber stoppers, comprising the steps of:
ejecting pressurized water, fed from a water storage division, from a jet nozzle to form a jet stream flowing into a negative pressure-creating pipe for suction to create a negative pressure inside the negative pressure-creating pipe;
transporting rubber stoppers placed in a storage section to the negative pressure-creating pipe through a cleaning inlet port placed under the storage section using the negative pressure;
cleaning the rubber stoppers with the jet stream while the rubber stoppers are being transported through the negative pressure-creating pipe and then a transportation pipe directly connected to the negative pressure-creating pipe;
transporting the rubber stoppers to a water separation section to remove water from the rubber stoppers; and
transporting the rubber stoppers to a stocker for storing the cleaned rubber stopper.

2. The method according to claim 1, further comprising the step of feeding back the cleaned rubber stoppers, placed in the stocker or treated with the water separation section, to the storage section, thereby cleaning and transporting the rubber stoppers through the negative pressure-creating pipe and the transportation pipe a plurality of times.

3. An apparatus for cleaning and transporting rubber stoppers, comprising:
a storage section, having a cleaning inlet port placed under the storage section, for storing rubber stoppers;
a cleaning/transporting unit connected to the cleaning inlet port; and
a water separation section for removing water from the rubber stoppers cleaned with the cleaning/transporting unit,
wherein the cleaning/transporting unit includes a negative pressure-creating pipe for suction and a jet nozzle for ejecting pressurized water fed from a water storage division to form a jet stream flowing into the negative pressure-creating pipe to create a negative pressure inside the negative pressure-creating pipe and the rubber stoppers placed in the storage section are discharged through the cleaning inlet port using the negative pressure.

4. The apparatus according to claim 3, further comprising a means for recovering the rubber stoppers, treated with the water separation section, stored in the storage section, wherein the recovering means includes a negative pressure-creating pipe for recovery and a jet nozzle for ejecting pressurized water to form a jet stream flowing into the negative pressure-creating pipe to create a negative pressure inside the negative pressure-creating pipe and the rubber stoppers placed in the storage section are transported using the negative pressure.

5. The apparatus according to claim 3, wherein the jet stream ejected into the negative pressure-creating pipe is surrounded by an air layer and thereby converted into a multiphase jet stream.

6. The apparatus according to claim 4, wherein the jet stream ejected into the negative pressure-creating pipe is surrounded by an air layer and thereby converted into a multiphase jet stream.
